(19) United States
(12) Patent Application Publication
(10) Pub. No.: US 2017/0129353 A1
(43) Pub. Date: May 11, 2017

(54) POWER SUPPLY ASSEMBLY INTENDED TO RECHARGE ELECTRIC BATTERIES FOR ELECTRIC MOTOR VEHICLES

(71) Applicant: NEXANS, Paris (FR)

(72) Inventors: Reynald Bois, Reims (FR); Antonio Leon Romero, Vilvoorde (BE); Annie Cheenne-Astorino, La Selle La Forge (FR); Mickael Sablon, Sedan (FR); Kristof Rottiers, Lede (BE)

(21) Appl. No.: 14/933,218

(22) Filed: Nov. 5, 2015

(51) Int. Cl. B60L 11/18; H02J 7/00

(52) U.S. Cl. CPC B60L 11/1825; H02J 7/0027; H02J 7/0045

(57) ABSTRACT

The invention relates to a power supply assembly intended to recharge electric batteries for several vehicles introducing a plurality of electricity transmission devices (1A, 2A) intended to be placed on the ground with a conductive arrangement (1B, 2B) positioned in said electricity transmission device and including at least one post supporting a power supply terminal and positioned on said electricity transmission devices. According to the invention—each said electricity transmission device is made up of a set of conductive strips (1B, 2B) coated in a bar of an electrically insulating material—at each of those ends, said bar has a perpendicular extension (1C, 1D, 2C, 2D) at the end of which said conductive strips (1B, 2B) are accessible, said bar and its said extensions forming a U-shaped structure whereof the substantially horizontal bar is the base provided with arrangements for fastening to the floor and the substantially vertical extensions are the branches,—said conductive strips are accessible at the free end of said extensions,—each power supply device is adjacent to at least one other power supply device and said adjacent perpendicular extensions of these power supply devices are electrically connected to each other and to a corresponding shared power supply terminal.

The invention relates to a power supply assembly intended to recharge electric batteries for several electric motor vehicles.

An assembly for supplying electricity for motor vehicles is described in patent document WO 2010/114455.

This power supply assembly intended to recharge electric batteries for several vehicles includes terminals each supported by a post anchored in the floor and a lower protection arrangement covering the electric cables disposed on the floor. This lower protection device is made of mechanically resistant material and includes several assembled modules.

This type of device poses a number of technical problems.

The assembly of said device is relatively long and complex. A protection device module also forming the base of an inner post, is placed and fixed on the floor, this inner post being anchored in the floor. It is then necessary to push the cables into this protection device and between the inner post and a sliding outer post, supporting the terminal. This operation must be repeated depending on the number of terminals to be installed. It has relatively little potential for extension.

This known device may also present problems with regard to tightness. In fact, water may infiltrate just as much within the lower protection devices as between the inner and outer posts. The electric cables must therefore be well insulated individually.

The invention overcomes these problems by proposing a power supply assembly intended to recharge electric batteries for several electric motor vehicles that can be installed particularly easily whilst providing total mechanical and electrical security.

To do this, the invention proposes a power supply assembly intended to recharge electric batteries for several electric motor vehicles including a plurality of electricity transmission devices intended to be placed on the floor with a conductive arrangement disposed in said electricity transmission device and including at least one post supporting a power supply terminal and disposed on said electricity transmission devices, characterized in that:
each said electricity transmission device is formed by a set of conductive strips coated in a bar of electrically insulating material,
said bar has, at each of these ends, a perpendicular extension at the end of which said conductive strips are accessible, said bar and its said extensions forming a U-shaped structure of which the substantially horizontal bar is the base provided with arrangements for fastening to the floor and the substantially vertical extensions are the branches,
said conductive strips are accessible at the free end of said extensions,
each power supply device is adjacent to at least one other power supply device and said adjacent perpendicular extensions of these power supply devices are electrically connected to each other and to a corresponding shared power supply terminal.

The electricity transmission device makes it possible to transmit low-voltage electricity intended to charge the battery of an electric motor vehicle, but also may make it possible to transmit various data, for example ensuring a communication of information to the user or an order by the user of a charging time of day or charging period, and also a remote maintenance toward a central unit in the event of a faulty terminal for example.

In addition, the assembly according to the invention does not require any excavation work or equivalent structural engineering.

This assembly is completely capable of being extended and can be expanded as desired. It can be expanded in a straight line, in a star shape, or in a curved line. It does not require a perfectly flat terrain and therefore adapts to all floor surfaces. It is resistant to polluting products, such as hydrocarbons and solvents, is resistant to impacts and resistant to fire.

In accordance with a preferred embodiment., said adjacent perpendicular extensions are covered by said post arranged atop said extensions and disposed below said terminal.

Said bar is preferably trapezoidal in section, its greatest face being intended to be disposed on the floor or equivalent.

It may also have a different form, ensuring the possibility of being driven over by a vehicle without damage. By way of example, it may have a semi-circular sectional shape.

Said bar preferably has a length between 2 and 3meters.

A longitudinal neutral strip and/or ground strip coated in said bar preferably covers said longitudinal phase strips.

In accordance with a first particular embodiment, at least one of said perpendicular extensions has a straight cylindrical cavity.

In addition, at least one of said perpendicular extensions may have a straight cylinder.

Advantageously, in this case, the radius of said cylinder and of said cavity is identical.

In accordance with a second particular embodiment, two of said perpendicular extensions having a straight cylindrical cavity are assembled with each other by way of a tubular element of the same radius, encased in each of said straight cylindrical cavities.

These features enable a high ease of positioning, whilst ensuring an angular displacement between devices.

The invention is described hereinafter in greater detail with the aid of drawings showing preferred embodiments of the invention,

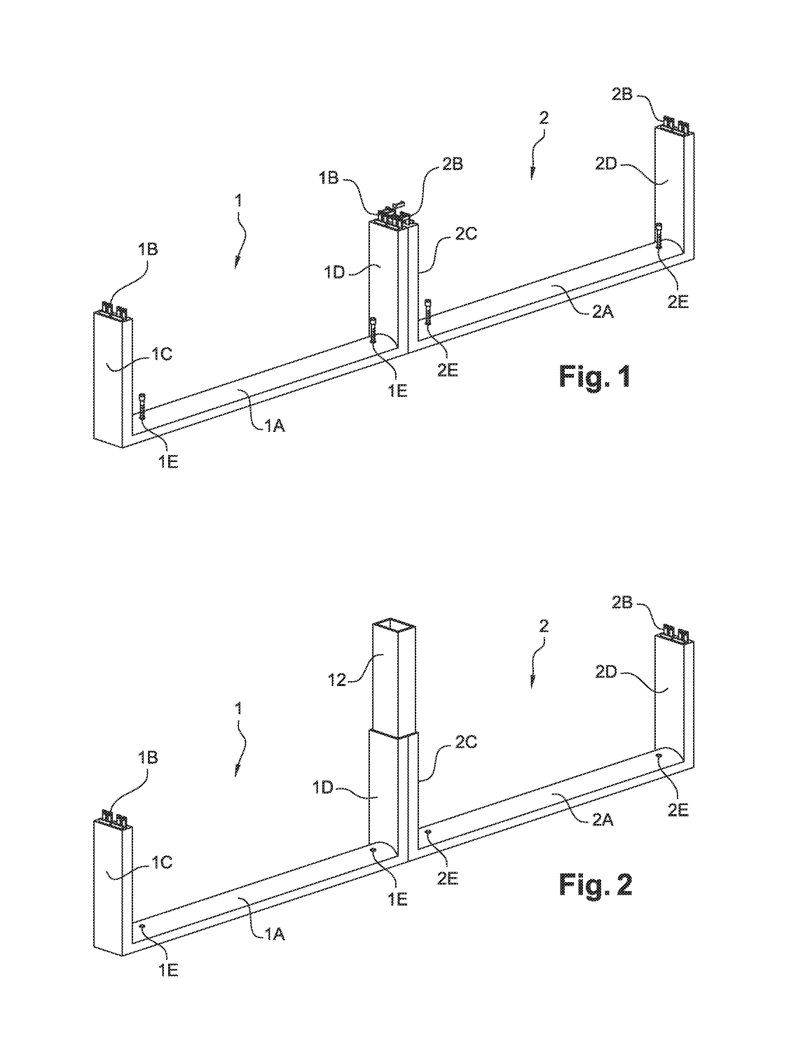

FIGS. 1 and 2 are perspective views of two devices for supplying electricity according to the invention, in accordance with a first, embodiment.

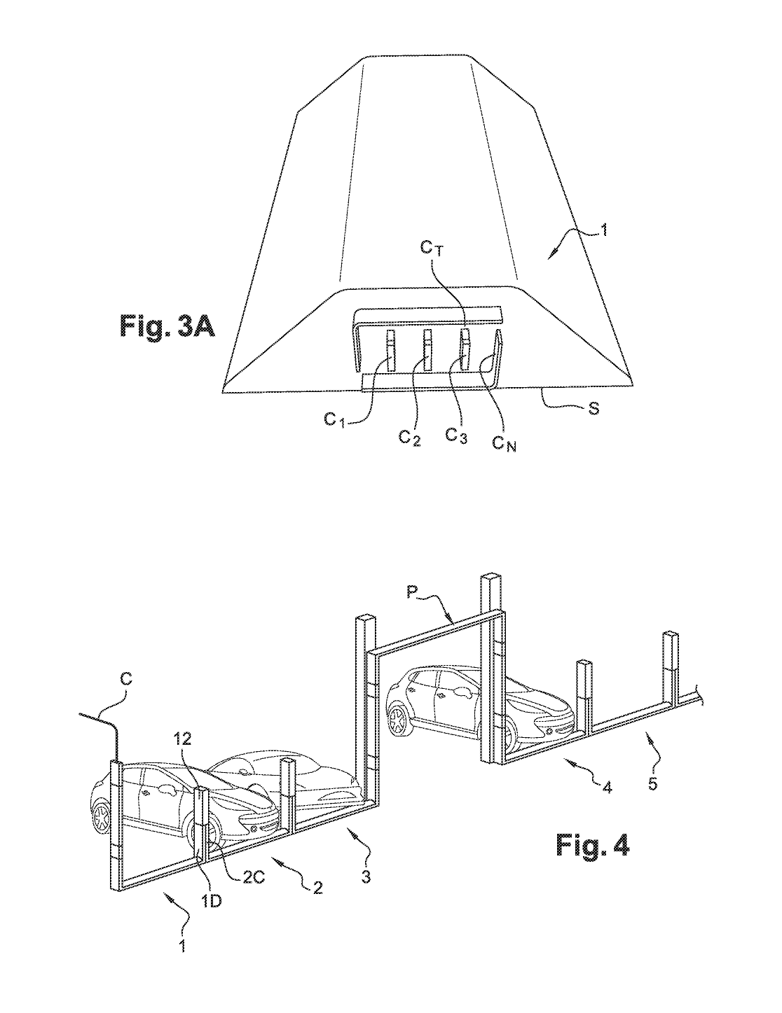

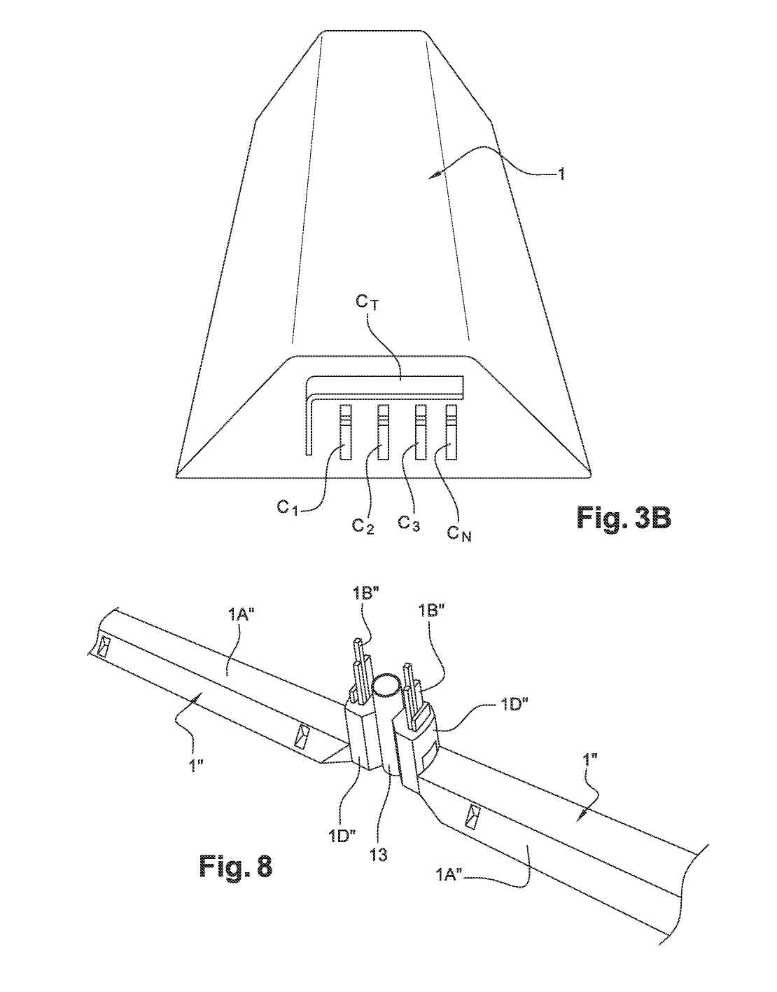

FIGS. 3A and 3B are sectional views of two variants of this device for supplying electricity.

FIG. 4 is a perspective view of a corresponding power supply assembly according to the invention.

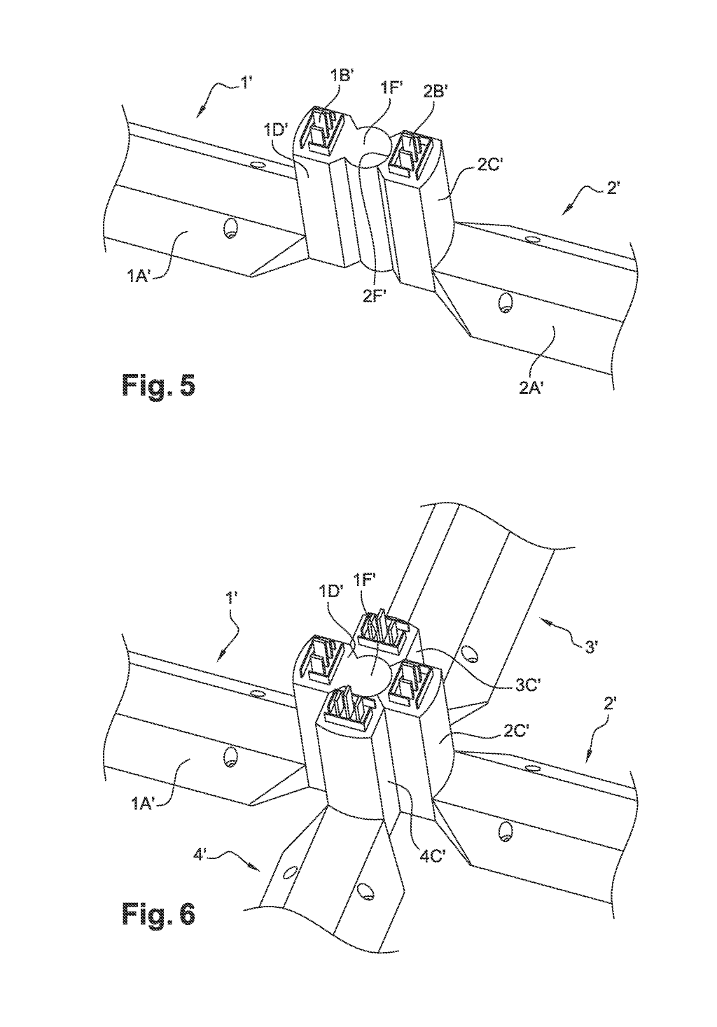

FIG. 5 is a partial perspective view of two devices for supplying electricity according to the invention, in accordance with a second embodiment.

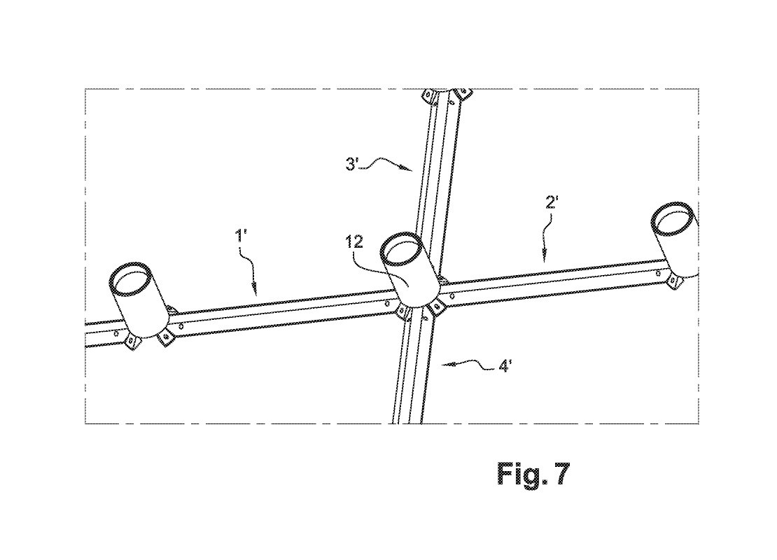

FIGS. 6 and 7 are partial perspective views of a corresponding power supply assembly.

FIG. 8 is a partial perspective view of two devices for supplying electricity according to the invention, in accordance with a third embodiment.

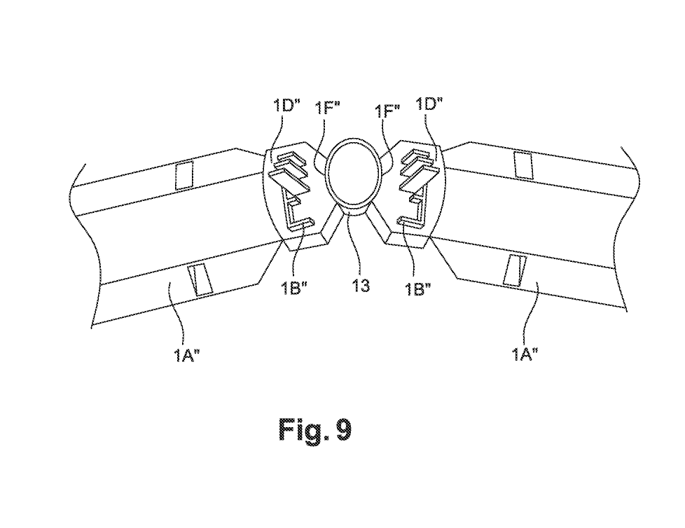

FIG. 9 is a partial view from above of a corresponding power supply assembly.

As illustrated in FIG. 1, in which two devices for supplying low-voltage electricity according to the invention are shown, a device for supplying electricity 1 or 2, intended in particular to recharge electric batteries for a vehicle, includes an electricity transmission device 1A, 2A intended to be placed on the floor or equivalent with a conductive arrangement disposed in this transmission device.

This electricity transmission device 1A, 2A is formed of a set of conductive strips 1B, 2B coated in a bar made of electrically insulating material, the conductive strips 1B, 2B being accessible at the two ends of the corresponding bar.

More precisely, the bar 1A, 2A has, at each of its ends, a perpendicular extension 1C, 1D, 2C, 2D, at the end of which the conductive strips 1B, 2B are accessible.

The bar is provided with an arrangement for fastening to the floor or equivalent, advantageously through-holes 1E, 2E, intended to receive screws or anchoring bolts introduced into the floor or equivalent.

The conductive strips 1B, 2B are preferably made of copper or aluminum and are coated in an insulating resin used conventionally for electric bars referred to commonly as “bus bars”. The section of the conductive strips is determined on the basis of the maximum number of places of the complete power supply assembly, which will be described further below.

Such a bar has a mechanical solidity making it possible to prevent damage thereto in the event that it is driven over by a vehicle, for example. To implement this, as can be seen in FIG. 3, the bar is preferably trapezoidal in section, its greatest face S being intended to be disposed on the floor or equivalent.

In addition, it is completely safe for third parties, for example in the event of impact with a sharp object. To implement this, as can also be seen in FIG. 3A, the conductive arrangement includes three longitudinal phase strips C₁ to C₃ surrounded at the top by a longitudinal ground strip C_{T} and at the bottom by a longitudinal neutral strip C_{H}, thee two latter strips, which are L-shaped in section, surrounding the three phase strips. Thanks to this arrangement, in the extreme case that the bar is broken by an object, which would come into contact with a phase strip C₁ to C₃, the object is forced to first pass through the ground strip C_{T} or the neutral strip C_{N}, which causes a phase/neutral or phase/ground short circuit. Safety arrangements arranged upstream then disconnect the electric current.

In accordance with a more economical variant shown in FIG. 3B, the conductive arrangement includes three longitudinal phase strips C₁ to C₃ surrounded at the top and on a first side by a longitudinal ground strip C_{T} of L-shaped section and on the second side by a longitudinal neutral strip C_{N}, this longitudinal neutral strip C_{N} being aligned with and parallel to the phase strips. Thanks to this arrangement, in the extreme case that the bar is broken by an object, which would come into contact with a phase strip C₁ to C₃, the object is forced to first pass through the ground strip C_{T}, which causes a phase/earth or phase/neutral short circuit. Safety arrangements arranged upstream then disconnect the electric circuit.

Such a modular device makes it possible to provide a power supply assembly that is totally and easily capable of being extended intended to recharge electric batteries for several vehicles, as shown in FIG. 4.

This assembly is formed of a plurality of power supply devices, as described above. More precisely, five power supply devices 1 to are shown in FIG. 4. Each power supply device is fixed to the floor or equivalent and is adjacent, to another power supply device, and the adjacent perpendicular extensions, for example 1D and 2C, of these power supply devices are electrically connected. More precisely, the accessible parts of the conductive strips are electrically connected to the end of the adjacent perpendicular extensions preferably by means of flexible connections.

A shared corresponding power supply terminal (not shown) is then installed above these extensions, for example 1D and 2C, and is mechanically connected to the floor or equivalent. This terminal is electrically connected, preferably by means of flexible connections, to the conductive strips accessible at the end of these extensions.

A hollow post, for example 12, is disposed between the extensions and the terminal, said post being arranged atop the extensions and supported by the floor or equivalent. Its function is to mechanically and electrically protect the electrical connections between extensions and terminal and to assure the tightness thereof.

Power supply devices, terminals and posts are fixed independently to the floor or equivalent in order to prevent any transmission of mechanical stress between these elements.

A first power supply device, here the device 1, is connected to input cables C by connection of these cables C with the conductive arrangement of this first power supply device 1.

In addition, this type of modular device makes it possible to easily form an entry gantry P in a car park by means of mechanical and electrical profiled connection elements, without the need to interrupt the electrical transmission between power supply devices.

The bar of each power supply device 1 to 5 preferably has a length between 2 and 3 meters, corresponding to a conventional parking space width. This length is preferably approximately 2.50 meters.

FIGS. to 7 illustrate a second embodiment according to the invention.

Here, at least one of the extensions 1D′ perpendicular to the bar 1A′ has a straight cylinder 1F′ and at least one of the extensions 2C′ perpendicular to the bar 2A′ has a straight cylindrical cavity 2F′, the radius of this cylinder and of this cavity being identical.

As shown in FIG. 5, two power supply devices 1′, 2′ can be assembled with a possible rotation of this cylinder 1F′ in this cavity 2F′, which allows an adjustment of the position relative to these two devices depending on the floor on which they are installed or depending on the desired form of the power supply assembly.

In particular, as illustrated in FIG. 6, it is possible to also associate three or four power supply devices 1′ to 4′, of which one 1 includes an extension 1D′ perpendicular to the bar 1A′ equipped with a straight cylinder 1F′ and of which the three others include an extension 2C′, 3C′, 4C′ perpendicular to the bar 2A′, 3A′, 4A′ equipped with a cylindrical cavity.

As illustrated in FIG. 7, a post, for example 12, is arranged atop the adjacent extensions, and the terminal (not shown) can then be installed.

FIGS. 8 to 9 illustrate a third embodiment according to the invention.

Here, all of the extensions 1D″ perpendicular to each bar 1A″ have a straight cylindrical cavity 1F″, and two adjacent perpendicular extensions are assembled with each other by way of an independent tubular cylindrical element of identical radius 13 encased in each of the straight cylindrical cavities. Only one type of device therefore has to be manufactured and assembled.

As shown in FIG. 9, two identical power supply devices 1″ can be assembled with a possible rotation about the tubular element 13 thanks to the cavities 1F″, which enables an adjustment of the relative position of these two devices depending on the floor on which they are installed or depending on the desired shape of the power supply assembly.

As before, a post is arranged atop the adjacent extensions, and the terminal (not shown) can then be installed.

On the basis of this principle, thanks to these two embodiments, all sorts of grids are possible depending on the ground on which the power supply devices are installed or depending on the desired shape of the power supply assembly.

1. A power supply assembly for recharging electric batteries for several electric motor vehicles comprising:
a plurality of electricity transmission devices for placing on the floor;
a conductive arrangement disposed in said electricity transmission device and including at least one post supporting a power supply terminal and disposed on said electricity transmission devices, wherein:
each said electricity transmission device is formed by a set of conductive strips coated in a bar of electrically insulating material,
said bar has, at each of these ends, a perpendicular extension at the end of which said conductive strips are accessible, said bar and its said extensions forming a U-shaped structure of which the substantially horizontal bar is the base provided with arrangements for fastening to the floor and the substantially vertical extensions are the branches,
said conductive strips are accessible at the free end of said extensions,
each power supply device is adjacent to at least one other power supply device and said adjacent perpendicular extensions of these power supply devices are electrically connected to each other and to a corresponding shared power supply terminal.

2. The assembly as claimed in the preceding claim, wherein said adjacent perpendicular extensions are covered by said post arranged atop said extensions and disposed below said terminal.

3. The assembly as claimed in claim, wherein said bar is trapezoidal in section, its greatest face (S) being intended to be disposed on the floor or equivalent,

4. The assembly as claimed in claim 1, wherein said bar has a length between 2 and 3 meters.

5. The assembly as claimed in claim 1, wherein a longitudinal neutral strip and/or ground strip (C_{N}, C_{T}) coated in said bar covers said longitudinal phase strips (C₁ to C₃).

6. The assembly as claimed in claim 1, wherein at least one of said perpendicular extensions has a straight cylindrical cavity (2F′).

7. The assembly as claimed in claim 1, wherein at least one of said perpendicular extensions has a straight cylinder (1F′).

8. The assembly as claimed in claim 6, wherein the radius of said cylinder and of said cavity is identical.

9. The assembly as claimed in claim 6, wherein two of said perpendicular extensions having a straight cylindrical cavity are assembled with each other by way of a tubular element of the same radius, encased in each of said straight cylindrical cavities.
